(19) United States
(12) Patent Application Publication
(10) Pub. No.: US 2005/0097151 A1
(43) Pub. Date: May 5, 2005

(54) System and method for creating a network directory

(76) Inventor: Omar Farooq Sayed, Chandler, AZ (US)

Correspondence Address: GAMMAGE & BURNHAM, PLC;c/o PortfolioIP, P.O. BOX 52050, Minneapolis, MN, 55402, US

(21) Appl. No.: 10/750,319

(22) Filed: Dec. 31, 2003

Related U.S. Application Data
(60) Provisional application No. 60/516,223, filed on Oct. 31, 2003.

(51) Int. Cl. G06F 17/30

(52) U.S. Cl. 707/204

(57) ABSTRACT

A system and method for using an existing computer network directory of a master entity, for example the publisher of an Internet online shopping mall, to provide a new computer network directory that facilitates the tracking of referrals from and the consolidated payment of commissions to a subordinate entity that desires to create, for example, a new online shopping mall. The subordinate entity may customize the new mall, at least in part, by selecting certain providers, for example merchants, from the existing directory or mall of the master entity for inclusion in the new directory. The subordinate entity may establish communications with the master entity over the Internet, and the subordinate entity may be presented with a series of options, rules and templates to define a customization model to use in creating the new directory. The master entity may assign a master identifier to the subordinate entity and associate this master identifier with provider identifiers corresponding to the subordinate entity that are provided by providers listed in the new directory to assist in tracking referrals from the subordinate entity.

### RELATED APPLICATIONS

This application is a non-provisional application claiming benefit under 35 U.S.C. sec. 119(e) of U.S. Provisional Application Ser. No. 60/516,223, filed Oct. 31, 2003 (titled SYSTEM AND METHOD FOR CREATING A NETWORK DIRECTORY by Omar F. Sayed), which is incorporated in full by reference herein.

### BACKGROUND OF THE INVENTION

The present invention relates in general to systems and methods for managing information in a computer network, and more specifically, for using portions of the data for an existing computer network directory of a master entity to provide a new, customized computer network directory for a subordinate entity.

Online shopping malls are commonly used on the Internet and typically are provided to a potential customer using a website that may be accessed by the customer with an Internet browser. Such malls typically present a directory of merchants that are willing to provide goods and/or services to the customer. The directory sometimes is organized into categories associated with different classes of goods and services such that the customer can click on a selected category to see a list of merchants associated with that category. Also, customers are sometimes able to search for particular products or merchants in such malls.

It is common for the entity that publishes an online shopping mall to have contractual relationships with the merchants that are listed or otherwise accessible through the mall. Such relationships are often referred to as affiliate relationships and typically provide that the publishing entity receives a share of revenue or a commission from the merchant for any sales resulting from customers accessing the merchant's website by clicking on an Internet link or Uniform Resource Locator (URL) found on the publishing entity's website. For example, the link that leads to a merchant's online store may pass an affiliate identification code to the merchant for tracking the source of the referral, so that the agreed commission can be paid to the referring shopping mall.

The effort to create an online shopping mall with a sufficient number of merchants to be of commercial interest to potential customers can be considerable and require several months of work. Often, such a mall may contain a thousand or more merchants, with underlying contractual relationships with most or all of the merchants. Occasionally, when creating a new online shopping mall, some of the merchants to be included in the new mall may have been previously established as merchants in an existing mall. However, existing approaches require significant time and effort to include any of these existing merchants in the new mall being created. Thus, it would be desirable to have a system and method that reduces the time and effort required to create new online shopping malls and that facilitates the incorporation of merchants from existing malls into newly-created malls.

### BRIEF DESCRIPTION OF THE DRAWINGS

The invention is pointed out with particularity in the appended claims. However, for a more complete understanding of the present invention, reference is now made to the following figures, wherein like reference numbers refer to similar items throughout the figures:

FIG. 1 illustrates the use of an existing computer network directory of a master entity in the creation of a new, customized directory in accordance with an embodiment of the present invention;

FIG. 2 illustrates a server environment of a master entity in accordance with an embodiment of the present invention;

FIG. 3 illustrates selected commission revenue flow paths for a newly-created shopping network in accordance with an embodiment of the present invention; and

FIG. 4 illustrates master entity and subordinate entity hosting server interactions in accordance with an embodiment of the present invention.

The exemplification set out herein illustrates an embodiment of the invention in one form, and such exemplification is not intended to be construed as limiting in any manner.

### DETAILED DESCRIPTION OF THE DRAWINGS

The following description and the drawings illustrate specific embodiments of the invention sufficiently to enable those skilled in the art to practice it. Other embodiments may incorporate structural, logical, process and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents.

The elements that implement the various embodiments of the present invention are described below, in some cases at an architectural level. Many elements may be configured using well-known structures. The functionality and processes herein are described in such a manner to enable one of ordinary skill in the art to implement the functionality and processes within the architecture.

As used herein, the term “entity” refers to an individual, corporation, partnership, or other type of legal entity. As used herein, “affiliate” refers to an entity that promotes the products or services of a provider in exchange for a commission or other payment or consideration for referrals made to the provider. An online affiliate typically displays banners, advertisements, text links or products on a website and is paid a commission by the provider when a visitor the website takes a specific action, such as filling out a form or making a purchase from the provider. As used herein, “provider” generally means a provider of goods and/or services. A provider typically receives payment or other consideration for providing such goods and/or services. By way of example, a provider may have advertisements and links to its products and services published on websites of affiliates and pay those affiliates a commission for referrals that result from the affiliate's site.

The present invention provides a system and method for using selected portions of data from an existing computer network directory of a master entity, for example the publisher or owner of an Internet-based online shopping mall, to provide a new computer network directory for a subordinate entity that desires to create, for example, a new online shopping mall. In accordance with an embodiment of the present invention, the subordinate entity may customize the new mall, at least in part, by selecting certain providers, for example merchants, from the existing directory or mall of the master entity for inclusion in the new directory, as further discussed below.

The subordinate entity may establish computer communications with the master entity, for example, over the Internet. Using this communications link, the subordinate entity may be presented, for example, with a series of options, rules and templates and/or other logic or means to permit the subordinate entity to define a customization model encompassing the criteria that will be used in creating the new directory.

After establishing a customization model, the new directory may be created by the master entity from the existing computer network directory using the customization model to, for example, determine which merchants from the existing directory will be included in the new directory. The creation process may further use the data or other information that defines the electronic, contractual and/or other relationships between the master entity and each provider and customize these relationships during the creation process as controlled, at least in part, by the customization model.

A subordinate entity is generally an entity for which a new customized directory is created using selected portions of data from an existing directory of the master entity. As a more specific example, the subordinate entity may be an existing provider to a shopping mall controlled by the master entity that is currently providing commissions to the master entity for sales directed to the subordinate entity from the master entity, for example from a website published by the master entity. The subordinate entity and the master entity may desire that a new shopping mall be created to be controlled in whole or in part by the subordinate entity. The new mall may be created so that a selected portion of the merchants for which the master entity is an affiliate are used in the new mall. The master entity may maintain control over tracking or other aspects of activities occurring in the new mall to facilitate collection and payment of commissions or other revenues to or from the subordinate entity and from some or all of the merchants that are newly associated with the subordinate entity in the new mall.

In one aspect of the invention, the master entity may create a subaccount for each subordinate entity. As part of creating this subaccount, the master entity may assign an identifier (the “master identifier”), such as for example an identification number, to each subordinate entity. The master identifier may be used by the master entity to track transactional or other activity referred by or otherwise sourced from or with the assistance of the subordinate entity. The master entity may further act as an administrator of new identifiers that may be generated by each of the providers (the “provider identifiers”) with each identifier corresponding to a subordinate entity creating a new directory.

The provider identifiers may be associated by the master entity with the master identifier so that referrals from subordinate entities may be tracked by the master entity. This association may be implemented, for example, by a translation table maintained on a server operated by the master entity. The subordinate entity does not need to receive the provider identifiers. The provider identifiers may be, for example, passed by the master entity to the provider in a link used by a customer referred by the subordinate entity. When the provider, for example, completes a transaction based on this referral, the provider may send a commission payment to the master entity along with the applicable provider identifier. The master entity may then pass this payment on to the subordinate entity, as described in more detail below, along with any other payments that may be due to the subordinate entity.

In another aspect of the invention, the master entity and/or the subordinate entity may facilitate the creation of further new computer network directories for use by further subordinate entities that use the original subordinate entity's directory as an existing directory. These further new directories may be the basis for a multiple-level or multiple-tier shopping or other type of provider computer network that generates commissions or revenues for the master entity and/or the subordinate entity from each level of sales.

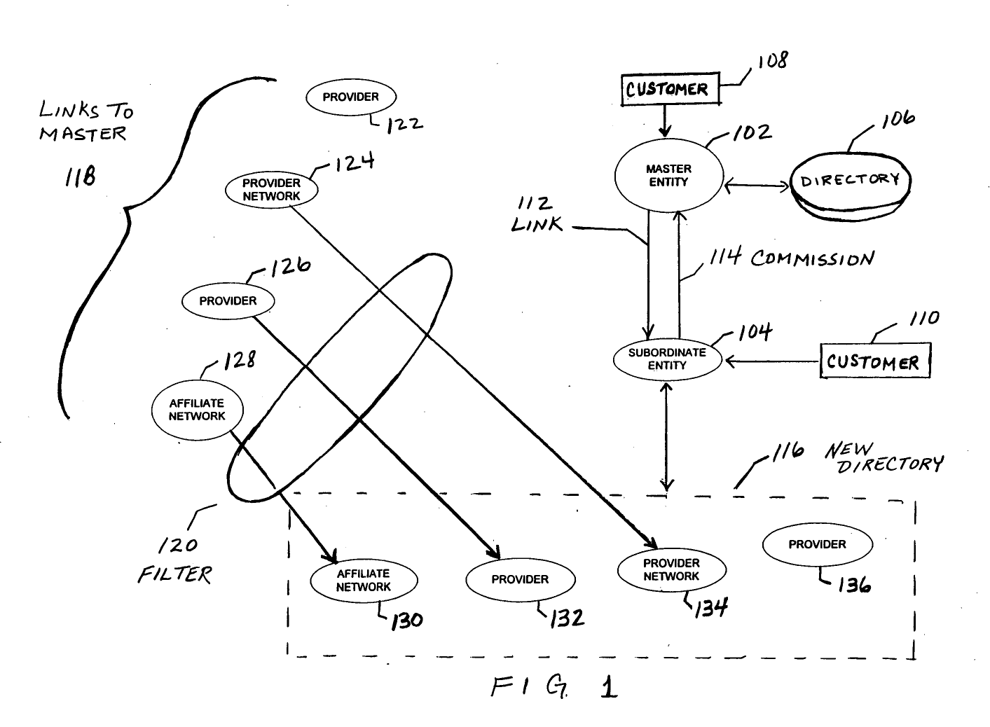

FIG. 1 illustrates the use of an existing computer network directory 106 of a master entity 102 to create a new, customized directory 116 in accordance with an embodiment of the present invention. Master entity 102 is, for example, a publisher of an online shopping mall, a general contractor or other type of entity that has established contractual or commercial relationships with one or more other entities in which communications and coordination of the transfer of information occurs over the Internet or another communications network, or a provider of services or resources some or all of which may involve computer network communications or electronic data. Directory 106 is generally a list or set or collection of links or other network location and/or relationship information used for directing communications with or providing access to information associated with members of directory 106. The functionalities of the systems and methods described herein may be implemented in general using conventional computer program tools and languages.

Master entity 102 may have, for example, established contractual or other types of relationships with many providers that communicate with master entity 102 over a communications network such as the Internet. Specifically, subordinate entity 104 may be one of these providers for which directory 106 includes a link 112, which may be used to direct customer 108 of master entity 102 to, for example, a website (not shown) of subordinate entity 104. Subordinate entity 104 may provide a commission or other share of revenue or payment 114 to master entity 102 based on any purchases made by customer 108. As a specific example, customer 108 may be an online Internet shopper that clicks on link 112, which is placed in the shopping mall and refers customer 108 directly or indirectly to an online store of subordinate entity 104.

Similarly as discussed in general above, subordinate entity 104 may be provided with new directory 116. Directory 116 may be created using selected portions of data from directory 106 so that some or all of the members (e.g., providers, provider networks, or affiliate networks) of directory 106 are included in directory 116. In creating new directory 116, a customization model may be defined to determine which members and/or other information or data is copied and/or the customization made to each or all of the members or other information or data used during this creation process.

As an example, providers 122 and 126 and provider network 124 are members of directory 106. Directory 106 also may include links or other defined relationships to affiliate network 128. Provider network 124 is, for example, itself a top-level aggregator of goods and/or services provided by a one or multiple-level network of providers. Affiliate network 128 is, for example, itself a top-level affiliate of a one or multiple-level network of providers, which may be related by commission or other revenue sharing relationships. Each of providers 122 and 126, provider network 124, and affiliate network 128 may have a link 118 from, for example, a website of master entity 102. Links 118 may be, for example, Uniform Resource Locators (URLs) for permitting hypertext transport protocol (HTTP) communications over the Internet.

When creating new directory 116, a portion of the logic originally contained in directory 106 may be maintained to permit master entity 102, for example, to more readily manage an affiliate program for commercial activity occurring under subordinate entity 104. New directory 116 may be, for example, a searchable directory of online stores and include URLs or other links that permit customer 110 to access websites or other communications interfaces to those stores. As discussed further below, master entity 102 may manage the receipt and payment of commissions to subordinate entity 104 from sales made by such stores that were referred by subordinate entity 104. Master entity 102 may retain a share of such commissions.

As mentioned above, affiliate network 128 represents a multi-level hierarchical network of affiliates in which network 128 is at the head of the hierarchy and network 128 itself has communications relationships and other data defined for this underlying hierarchy. Affiliate network 130 may be created using data stored in directory 106 for affiliate network 128 to maintain some or all of the communications relationships and other data (as may be customized by the customization model) in new directory 116. Provider 132 and provider network 134 may be created using any desired customization of the data stored in directory 106 for the corresponding provider network 124 and provider 126.

The customization model above may be defined in general by subordinate entity 104, master entity 102, or a third party. Typically, subordinate entity 104 will define all of the user-selectable elections or options of the customization model. For example, master entity 102 may provide Internet access to subordinate entity 104 to present a template or other means by which subordinate entity 104 may select or define characteristics and/or select categories to establish the customization model.

The customization model may be, for example, implemented as filter 120, which filters certain members of directory 106 and/or certain selected characteristics of or other information associated with each such member. Also, the customization model may, for example, in part define the look and feel of the newly-created shopping mall. Pre-designed templates, colors, and page and directory layouts may be selected by subordinate entity 104 as part of defining the customization model. Subordinate entity 104 may also define certain categories, for example product categories selected from a master list, that are to remain hidden or to be shown in a shopping mall based on directory 116, and may define certain providers to present to customers as preferred or featured merchants.

In the specific example illustrated in FIG. 1, provider 122 is not added to new directory 116 because filter 120 has defined selected categories (for example, certain limited product categories) in which provider 122 does not belong. Also, note that subordinate entity 104 may itself add additional members to new directory 116, such as new provider 136. Further, it should be noted that directory 106 and new directory 116 may contain members that are affiliates in addition to or instead of being providers.

As another specific example, subordinate entity 104 may create its own customized shopping mall (not shown) and visitors to this shopping mall such as customer 110 will generate commissions that may be shared by master entity 102 and subordinate entity 104. Also, this shopping mall may use master contractual relationships that master entity 102 has established with other providers, provider networks, or affiliate networks. Such contractual relationships may, for example, entitle master entity 102 to receive commissions for sales generated by referrals by master entity 102, including those made through any number of subordinate entities 104 that may be established by master entity 102. Subordinate entity 104 may benefit by receiving commissions from providers having a commission relationship with master entity 102, rather than devoting significant time and effort to independently establishing such commission relationships.

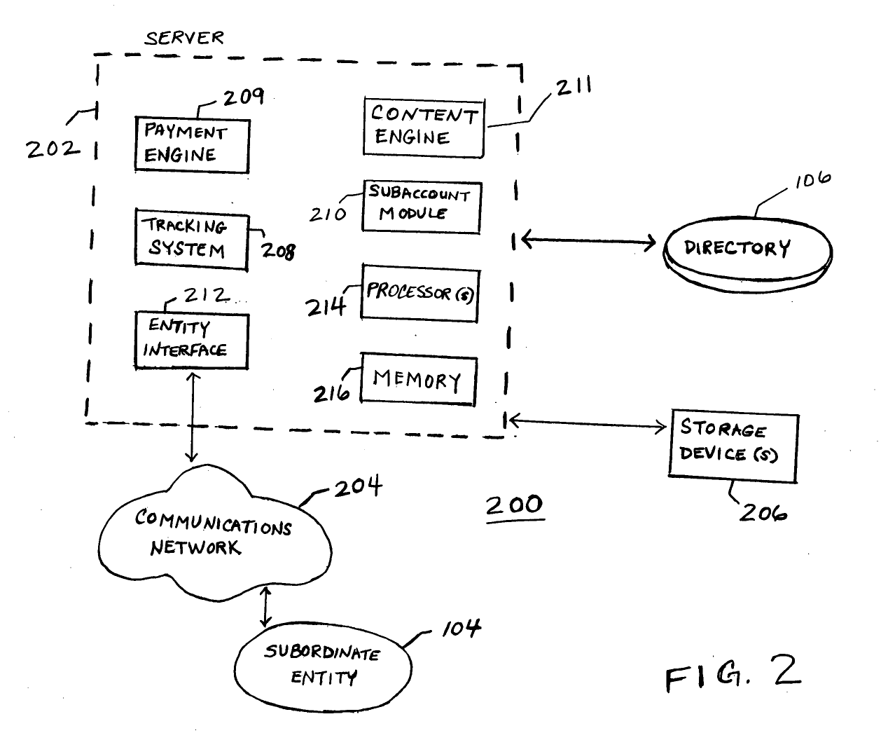

FIG. 2 illustrates a server environment 200 of master entity 102 in accordance with an embodiment of the present invention. Environment 200 includes server 202, which may be coupled to directory 106, storage device(s) 206, and communications network 204. Server 202 may be a conventional server computer or may be implemented as a set of server computers operating together at the same location or at dispersed locations. Directory 106 may be stored in a conventional database. Storage device(s) 206 may be, for example, a hard drive or other conventional storage device. Computer program code, which is used to operate server 202, may be stored, for example, on storage device(s) 206.

Communications network 204 may be, for example, the Internet, an intranet, an extranet, or other network that permits communications between different computers. Subordinate entity 104 may be coupled to server 202 by communications network 204. For example, an operator at subordinate entity 104 may use a conventional Internet web browser to access information provided by server 202. Alternatively, a computer controlled by subordinate entity 104 may be executing a computer program that communicates with server 202 via communications network 204.

Server 202 may include one or more processors 214 for executing computer program code on server 202, and also may include memory 216, such as, for example, dynamic random access memory, for storing program code and data during operation of server 202.

Server 202 may execute computer program code or software that comprises tracking system 208, subaccount module 210, entity interface 212, payment engine 209, and content engine 211. Tracking system 208 may track and record data related to commissions or revenues generated by or associated with commercial activity with any providers that are a member of new directory 116 (see FIG. 1). Subaccount module 210 may control the creation and management of a subaccount for each subordinate entity 104.

Entity interface 212 may provide the user and/or computer program interface for communications to and from subordinate entity 104. Entity interface 212 also may present the options and parameters that subordinate entity 104 may define for the customization model and pass these definitions to subaccount module 210.

Payment engine 209 may control the calculation and disbursement of payments to each subordinate entity 104. Content engine 211 may recast and render the content that will form new directory 116, and also control the definition of the customization model by subordinate entity 104. Content engine 211 may use the customization model to create directory 116.

Master entity 102 may have master accounts with one or more providers in directory 106. These master accounts typically require the payment of a commission to master entity 102 for referrals, and the payment may be, for example, conditioned solely the number of visits to or viewings of a provider's website by a customer or may further require that a purchase or other activity occur with the provider. The master accounts may be structured with providers so that agents of master entity 102 may make referrals to the providers on behalf of master entity 102 such that the provider is obligated to make the payment to master entity 102. Each subordinate entity 104 may act as one of these agents (e.g., as a subaffiliate), and master entity 102 may share payments from providers with each subordinate entity 104 as described in more detail below.

When a subordinate entity 104 desires to create a new directory 116, subaccount module 210 may create a subaccount for the subordinate entity 104. Subaccount module 210 also may manage each subaccount, which may include for example communicating with payment engine 209 to maintain account balances for each subordinate entity 104 so that regular payments can be made to each subordinate entity 104.

As mentioned above, some or all providers that have a master account with master entity 102 may provide an identifier for each subordinate entity 104. Tracking system 208 may maintain a translation table or other data structure to associate these identifiers with each new subaccount.

After a subaccount has been created for a particular subordinate entity 104, a customization model may be created as discussed herein. Entity interface 212 may provide content engine 211 with the user input provided by subordinate entity 104 in defining the customization model. Content engine 211 may use the customization model input to recast data from existing directory 106, and to create new data as may be required, in order to create new directory 116. A specific example of data that may be recast in this manner includes a commission payout schedule.

As an example, new directory 116 may be a new shopping mall customized by subordinate entity 104 as described herein. Content engine 211 may render the shopping mall by providing a set of hyperlinks and other data that can be used to display the shopping mall on a website. The rendered mall may be delivered electronically to subordinate entity 104. The rendered mall may be, for example, in the form of hypertext markup language (HTML) code.

Master entity 102 may define a set of master rules that govern operation of certain aspects of, for example, a shopping mall based on existing directory 106. As part of creating the customization model, subordinate entity 104 may provide input that is used to generate a subset of these master rules that will be applicable to, for example, a shopping mall based on new directory 116. Subordinate entity 104 may also provide input to generate additional new rules that do not violate the outer limits of master rules established by master entity 102. These subset and new rules may be used, for example, to govern the appearance and user interface and operation of the subordinate entity's shopping mall, the logical operation of the mall, and the manner of presentation of user content. Typically, most of these rules are processed on server 202 before the mall is presented, for example, in HTML code. Server 202 may, for example, process the master rules and the subordinate entity's rules and combine the results from processing of these rules into the content that is shown to a customer. In addition to the foregoing rules, subordinate entity 104 may also select preferences for the appearance of the mall such as color.

Content engine 211, when creating a new shopping mall or other directory for a subordinate entity 104, may automatically embed the identifier for subordinate entity 104, generated as described herein, into one or more of the individual links of the mall or in a directory of links. This is in contrast to prior approaches, which require that the subordinate entity itself, for example manually or otherwise using its own computer systems, embed a unique identifier into the links of its new shopping mall.

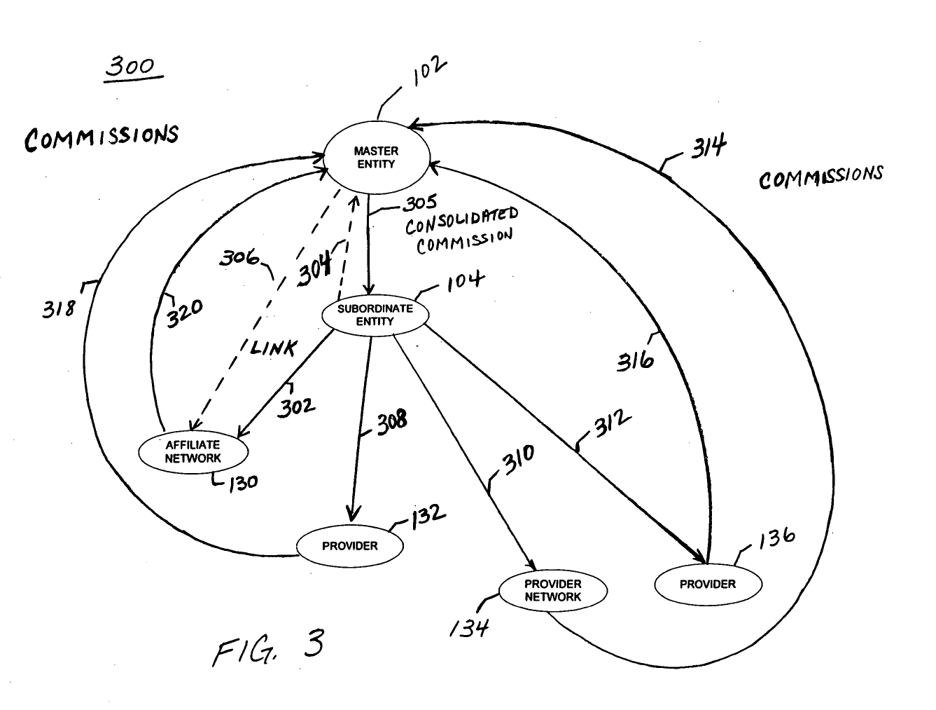

FIG. 3 illustrates selected commission or other revenue flow paths for a newly-created shopping network 300 in accordance with an embodiment of the present invention. Network 300 may include a contractual relationship between master entity 102 and subordinate entity 104 in which master entity 102 will provide consolidated commission 305 to subordinate entity 104 based on commercial activity promoted or referred by subordinate entity 104 using new directory 116. More specifically, new directory 116 may include relationship definitions or links 302, 308, 310 and 312 corresponding to members of new directory 116 such as affiliate network 130, providers 132 and 136, and provider network 134.

Master entity 102 and/or subordinate entity 104 may have relationships with the members of new directory 116 such that subordinate entity 104 receives commissions or a share of commissions for sales made by members of new directory 116. These commissions may be paid directly to subordinate entity 104 by each such member. Also, master entity 102 may act as a consolidator of commissions to be paid by each network member. For example, commissions 314, 316, 318 and 320 may be paid to master entity 102, rather than directly to affiliate 104, for subsequent payment as consolidated commission 305.

Each link 302, 308, 310, and 312 may alternatively be directed through server 202 (see FIG. 2) so that master entity 102 can directly track referrals made from new directory 116 and reconcile these referrals with commissions received by master entity 102. This is represented, for example, for one member in FIG. 3 by link 304 to master entity 102 and redirected link 306 to affiliate network 130. The information received by server 202 through operation of link 304 may include, for example, the identifier for the subordinate entity, generated as described above, and/or an identification code corresponding to the member of new directory 116 to which a referral is being made by subordinate entity 104. The reformatted link 304 passed on as link 306 also may include an identifier for master entity 102 so that the provider, for example making a transaction with a customer, will know both the master entity and the subordinate entity that referred the customer.

When a customer using link 304 is redirected as described above, link 304 may be reformatted by server 202 to include additional identification information. For example, tracking system 208 may use a translation table, as described above, to select the subordinate entity identifier previously provided by the provider, provider network, or affiliate network to which link 304 is directed by referencing the subordinate entity identifier generated by master entity 102. The reformatted link 304 may also include additional information dictated by the master business rules of master entity 102 and/or the new rules created by subordinate entity 104.

Tracking system 208 (see FIG. 2) may receive information from providers in new directory 116 regarding sales made based on referrals from subordinate entity 104 and also may track payments made directly to master entity 102 for such corresponding sales. As a specific example, master entity 102 may have existing contractual relationships with affiliate network 130, providers 132 and 136, and provider network 134 under which master entity 102 receives commissions for any sales referred by master entity 102 to any of their online stores. The commissions may vary significantly from one store to another. Master entity 102 may pay consolidated commission 305 as a share of the commissions that master entity 102 receives for sales generated through an online shopping mall created by subordinate entity 104 by the customized use of directory 106 as described above.

As a specific example, when each provider pays commissions directly to master entity 102 for sales referred by one or more of subordinate entities 104, each provider may provide a summary of transactions that generated commissions organized using the subordinate entity identifiers previously passed to the provider using link 306. Master entity 102 may aggregate commissions from many providers and create a payment schedule for paying a consolidated commission 305 to each subordinate entity 104. The passing of the subordinate entity identifiers to the providers may permit the tracking by master entity 102 of each individual transaction referred by subordinate entity 104.

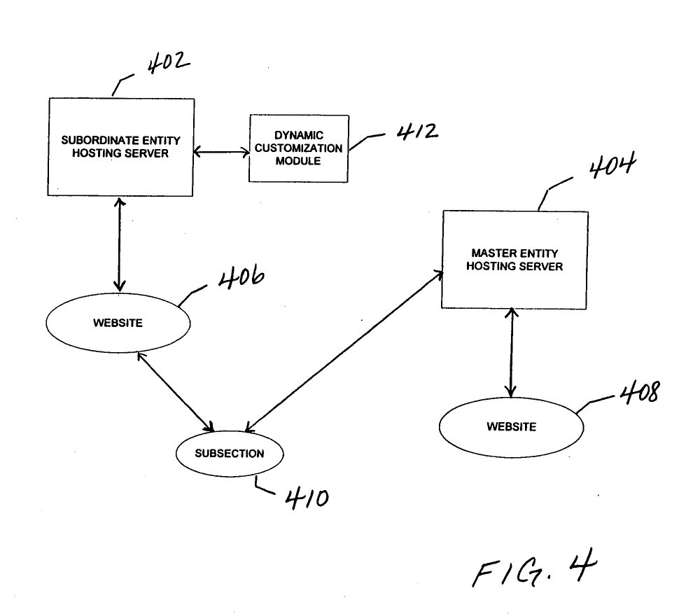

FIG. 4 illustrates master entity 102 and subordinate entity 104 hosting server interactions in accordance with an embodiment of the present invention. More specifically, hosting server 404 is controlled by master entity 102 and hosting server 402 is controlled by subordinate entity 104. Hosting server 404 may be implemented using server 202 (see FIG. 2) or may be implemented as a separate conventional server. Hosting server 404 may publish a website 408, for example, to publish a shopping mall or other electronic commerce site that is based in full or in part on directory 106.

Hosting server 402 may publish website 406 corresponding to, for example, an online shopping mall or other electronic commerce site of subordinate entity 104. Website 406 may be based on new directory 116, in whole or in part. Optionally, subsection 410 of website 406 may be based on new directory 116 and hosted by hosting server 404 of master entity 102.

It should be noted that website 406 may be hosted independently of any hosting server of master entity 102. Subordinate entity 104 may embed new directory 116 into website 406, or optionally into the body of an email, by adding, for example, a <JS>tag using conventional techniques. Also, website 406 may be based on a URL (based on either a sub-domain or an actual domain) that is independent of master entity 102, but hosted on hosting server 404.

Master entity 102 may track, for example, actual referrals to online stores by subordinate entity 104 by having links point to hosting server 404 (as mentioned above) and then initiate the actual referral link to a specific store from hosting server 404. Master entity 102 may also rely on reporting by the stores themselves regarding referrals and sales.

Dynamic customization module 412 may be implemented as computer program code running on hosting server 402 and may dynamically change the appearance of, for example, a shopping mall presented on website 406 based on rules defined in the customization model or otherwise by subordinate entity 104, master entity 102 and/or another entity. These rules may be, for example, conditional rules defined by subordinate entity 104 that dynamically change the images or search results presented to a customer. For example, the sorting, priority, and preferences of stores may be varied, specific links for a store may be enabled or disabled, and certain categories in a mall may be enabled or disabled. Customization module 412 may also be programmed with conditional rules that respond to activities of customers, for example, in a shopping mall based on new directory 116.

By the foregoing description, an improved system and method for using an existing computer network directory and a customization model to provide a new computer network directory have been described. The improved system and method may reduce the time and effort required to create a new online shopping mall and may facilitate the incorporation of providers from existing malls or other types of directories into newly-created malls or directories.

The foregoing description of specific embodiments reveals the general nature of the invention sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the invention embraces all such alternatives, modifications, equivalents and variations as fall within the spirit and scope of the appended claims.

1. A method for using an existing computer network directory of a first plurality of providers associated with a master entity to create a new computer network directory of a second plurality of providers associated with a subordinate entity, the method comprising:
establishing computer communications between the master entity and the subordinate entity;
defining a customization model;
using the existing computer network directory and the customization model to create the new computer network directory;
assigning an identifier corresponding to the subordinate entity; and
embedding, under computer control of the master entity, the identifier into at least a portion of the new computer network directory.

2. The method of claim 1 wherein the second plurality of providers is a subset of the first plurality of providers.

3. The method of claim 1 wherein the first plurality of providers offers goods, services or both goods and services.

4. The method of claim 1 wherein each of the first plurality of providers is associated in the existing computer network directory with a network location.

5. The method of claim 4 wherein each of the second plurality of providers is associated in the new computer network directory with a network location.

6. The method of claim 5 further comprising referring potential customers to one or more of the second plurality of providers by passing linking information for each of the one or more of the second plurality of providers through a hosting server controlled by the master entity.

7. The method of claim 6 wherein network location information for one or more of the first plurality of providers is copied at least in part to the new computer network directory.

8. The method of claim 4 wherein each of the first plurality of providers is associated in the existing computer network directory with a unique network location identified by a uniform resource locator.

9. The method of claim 1 further comprising providing a server controlled by the master entity and wherein defining the customization model comprises accessing the server by the subordinate entity to define the customization model.

10. The method of claim 1 wherein each of the first plurality of providers has a contractual duty to share at least a portion of its revenue with the master entity.

11. The method of claim 10 wherein one or more of the second plurality of providers has a contractual duty to share a least a portion of revenue with the subordinate entity.

12. The method of claim 11 wherein the portion of revenue of the one or more second plurality of providers is established by the contractual relationship of the master entity with the first plurality of providers.

13. The method of claim 11 further comprising sending revenue from the master entity to the subordinate entity corresponding to the portion of revenue of the one or more second plurality of providers.

14. The method of claim 1 wherein the new computer network directory is configured to provide a directory of merchants for online shopping by customers.

15. The method of claim 14 wherein defining the customization model comprises selecting by the subordinate entity of product categories to use in copying selected data from the existing computer network directory.

16. The method of claim 1 further comprising providing an online shopping environment for customers using the new computer network directory wherein customers may select a merchant from the new computer network directory for making a purchase.

17. The method of claim 16 wherein (i) the online shopping environment comprises a user interface and (ii) defining the customization model comprises defining conditional rules; and the method further comprising dynamically updating the user interface based on the conditional rules.

18. A computer system for using an existing computer network directory of a first plurality of providers associated with a master entity to create a new computer network directory of a second plurality of providers associated with a subordinate entity, comprising a computer for:
establishing computer communications between the master entity and the subordinate entity;
defining a customization model;
using the existing computer network directory and the customization model to create the new computer network directory;
assigning an identifier corresponding to the subordinate entity; and
embedding, under computer control of the master entity, the identifier into at least a portion of the new computer network directory.

19. A program product for use with a computer, having computer readable program code for using an existing computer network directory of a first plurality of providers associated with a master entity to create a new computer network directory of a second plurality of providers associated with a subordinate entity, the program product comprising:
computer readable program code for establishing computer communications between the master entity and the subordinate entity;
computer readable program code for defining a customization model;
computer readable program code for using the existing computer network directory and the customization model to create the new computer network directory.
computer readable program code for assigning an identifier corresponding to the subordinate entity; and
computer readable program code for embedding, under computer control of the master entity, the identifier into at least a portion of the new computer network directory.

20. A method for tracking referrals from a plurality of subordinate entities, wherein each of the plurality of subordinate entities markets to customers using a new computer network directory generated from selected portions of an existing computer network directory, wherein the existing computer network directory comprises a list of a first plurality of providers associated with a master entity, and wherein the new computer network directory comprises a list of a second plurality of providers associated with a subordinate entity, the method comprising:
defining a customization model;
using portions of data from the existing computer network directory as governed by the customization model to create the new computer network directory;
assigning, by the master entity, a master identifier corresponding to the subordinate entity;
assigning, by each of the second plurality of providers, a provider identifier corresponding to the subordinate entity; and
maintaining an association, by the master entity, between the master identifier and each provider identifier assigned by the second plurality of providers to track referrals from the subordinate entity.

21. The method of claim 20 further comprising embedding, under computer control of the master entity, the master identifier into at least a portion of the new computer network directory.

22. The method of claim 21 wherein the embedding comprises embedding the master identifier into one or more links of a shopping mall website based on the new computer network directory.
